(19) United States
(12) Patent Application Publication
(10) Pub. No.: US 2003/0223723 A1
(43) Pub. Date: Dec. 4, 2003

(54) Reconfigurable fiber optic cable management enclosure

(76) Inventors: Gaines N. Massey, Simpsonville, SC (US); George A. Walker, Simpsonville, SC (US); Thomas Dwyer, Greenville, SC (US)

Correspondence Address: Tracey D. Beiriger, Esq., Alcoa Inc., Alcoa Technical Center, 100 Technical Drive, Alcoa Center, PA, 15069-0001, US

(21) Appl. No.: 10/155,201

(22) Filed: May 28, 2002

(51) Int. Cl. G02B 6/00

(52) U.S. Cl. 385/135

(57) ABSTRACT

An enclosure for use in a cable management system includes an outer shell having a generally rectangular shape and defining an interior space, the outer shell including a bottom panel, a top panel and first and second sidewalls. A first reversible mounting bracket is provided for connection to the bottom panel, and a second mounting bracket is provided for connection to the top panel. The first and second mounting brackets can include means for supporting cable management devices. The mounting brackets can each include a generally L-shaped member having a first portion positioned adjacent to the top or bottom panel, and a second section positioned substantially perpendicular to the top or bottom panel. The means for supporting cable management devices can include a master plate that can be mounted between the brackets. The master plate can define one or more openings for attachment of the cable management devices.

### FIELD OF THE INVENTION

This invention relates to fiber optic cable management systems, and more particularly to enclosures for use in fiber optic cable management systems.

### BACKGROUND OF THE INVENTION

Fiber optic management systems provide termination and service access points for fiber optic circuits. Where a large number of fiber optic cables are to be connected, connections are typically made in fiber distribution frames. The frames can be comprised of multiple equipment racks that form bays for containing fiber optic management components, such as splice boxes and connection modules.

Enclosures for use in fiber optic cable management systems have been the subject of several patents, including U.S. Pat. Nos. 6,362,422; 6,215,938; 6,181,862; 5,898,129; 5,825,962; 5,778,130; 5,530,954; 5,208,894; 5,093,885; 4,971,421; 4,900,123; 4,824,196; 4,708,430; and 4,630,886.

Fiber optic cable enclosures can contain various cable management devices such as splice trays, connection modules, adapters, etc. In some instances, it would be desirable to be able to route cables from the rear of an enclosure to the front, and/or to rearrange the interior portions of the enclosure to perform different cable management functions.

There is a need for a fiber optic cable enclosure that can be easily reconfigured to accommodate various cable connection and routing needs.

### SUMMARY OF THE INVENTION

Enclosures for use in a cable management system constructed in accordance with this invention include an outer shell having a generally rectangular shape and defining an interior space, the outer shell includes a bottom panel, a top panel and first and second sidewalls. A first reversible mounting bracket is provided for connection to the bottom panel, and a second mounting bracket is provided for connection to the top panel. The first and second mounting brackets can include means for supporting cable management devices.

The mounting brackets can each include a generally L-shaped member having a first portion positioned adjacent to the top or bottom panel, and a second section positioned substantially perpendicular to the top or bottom panel.

The means for supporting cable management devices can include a master plate that can be mounted between the brackets. The master plate can define one or more openings for attachment of the cable management devices.

The enclosure can further include a door for covering a front opening of the enclosure, and a latch attached to the door, wherein the latch is positioned adjacent to the center of one edge of the door.

The enclosure can also include a mounting bracket attached to at least one of the sidewalls. The mounting bracket can define an opening for routing cables from the rear of the enclosure to the front of the enclosure. A cable shield can be provided for enclosing cables between the mounting bracket and an opening in the adjacent sidewall.

The cable shield can include a top portion having a flat section and a curved section, a front portion extending vertically downward for the top portion, a side portion conforming to the shape of the top portion and the front portion, and a tab attached to the top portion for connection to an adjacent mounting bracket.

### BRIEF DESCRIPTION OF THE DRAWINGS

FIG. 1 is an isometric view of an enclosure constructed in accordance with the invention;

FIG. 2 is an isometric view of selected components of the enclosure of FIG. 1;

FIG. 3 is a perspective view of a portion of the enclosure of FIG. 1;

FIG. 4 is a perspective view of another portion of the enclosure of FIG. 1;

FIG. 5 is a perspective view of a splice tray that can be used in the enclosure of FIG. 1;

FIG. 6 is a perspective view of a slack cable tray that can be used in the enclosure of FIG. 1;

FIG. 7 is a plan view of a bottom portion of the enclosure of FIG. 1 with cable trays in place;

FIG. 8 is an alternative plan view of a bottom portion of the enclosure of FIG. 1 with cable trays in place;

FIG. 9 is an isometric view of a master plate that can be used in conjunction with the enclosure of FIG. 1; and

FIG. 10 is an isometric view of the cable shield of the enclosure of FIG. 1.

### DETAILED DESCRIPTION OF THE INVENTION

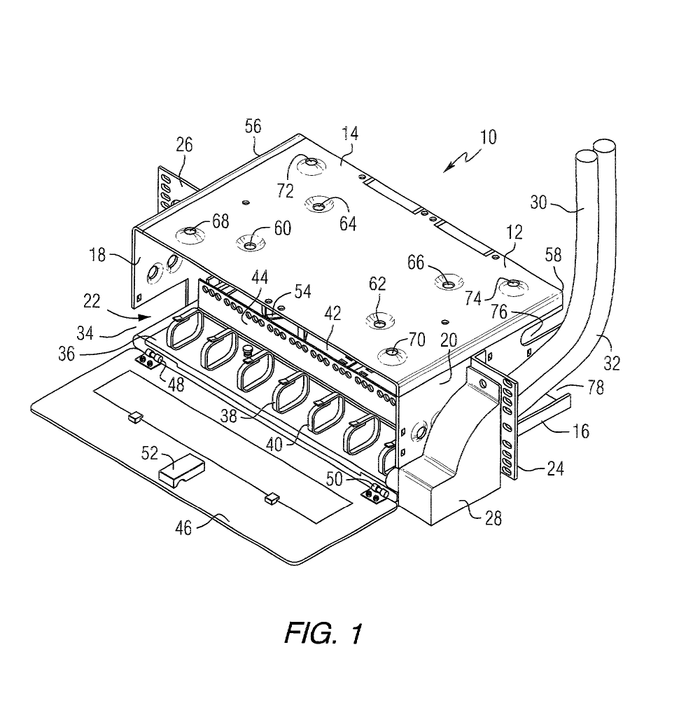

Referring to the drawings, FIG. 1 is an isometric view of an enclosure 10 constructed in accordance with the invention. The enclosure includes a generally rectangular shell 12 including top 14, a bottom 16, and first and second sides 18 and 20. The enclosure forms an interior space 22 that can accommodate a variety of well known fiber optic cable components, such as connectors, adapters, modules, etc.

Mounting brackets 24 and 26 are connected to the sidewalls and are provided for attaching the enclosure to an equipment rack. The brackets incorporate a pass through design in that holes are provided for cables to be passed from the rear of the enclosure to the front. Mounting bracket 24 is shown to provide a mounting location for the cable shield 28 which protects the cable from damage from falling debris. The cable shield covers the cables 30 and 32 from a point where they pass through mounting bracket 24 until they enter the enclosure through an opening similar to opening 34 in sidewall 18.

A first tray 36 is positioned in the interior of the enclosure near the front, and can include cable management devices such as clamps 38 and 40 for restraining cables within the enclosure. A second tray 42 is positioned in the interior of the enclosure near the back, and can include additional cable management devices. A reversible bracket 44 is positioned between the trays. Bracket 44 separates front and back sections of the enclosure. By changing the position of bracket 44, the relative sizes of the front and back sections change. Trays 36 and 42 can be mounted in either the front or the back of the enclosure, depending upon the position of bracket 44.

A door 46 is shown to be mounted to the front of the enclosure by hinges 48 and 50. The door is preferably made of a relatively thin and slightly flexible material, such as polycarbonate. A latch 52 is mounted adjacent to one edge of the door and substantially in the center of the edge. The latch couples to a clip 54 mounted on the enclosure. Since the latch is positioned near the center of one edge of the door, the edges of the door away from the latch can be deflected slightly in the event that a cable is pinned between the door and the front edge of the enclosure, thereby reducing the likelihood of excessive pinching of the cable.

The front door is provided with a single latch point for one hand operation. A second door can be provided on a rear opening of the enclosure and can similarly include a latch positioned near the center of one edge. Economic enclosure design incorporates rounded comers, for example 56 and 58, to prevent pinch points for fiber optic cable fibers and to give the enclosure a modern look. Rounded edges on various parts of the enclosure reduce snagging points for fiber optic cable strands, and reduce the possibility of microbends in the cable when pulled in tension over the edges of the enclosure.

Holes 60, 62, 64 and 66, are provided in top panel to accept a variety of hardware, such as a splice tray drawer mechanism, or a record rack type splice tray holding apparatus. Additional holes 68, 70, 72 and 74 facilitate joining two or more enclosures together if there should be a need to stack and join enclosures. The holes 68, 70, 72 and 74 are centered in outwardly facing dimples. Screws, or similar fastening means can be inserted in the holes and attached to an adjacent enclosure. The head of the fastening device can fit within the dimple so that it does not interfere with items being inserted in the enclosure. In addition, the outwardly facing dimples will maintain a small space between adjacent enclosures and provide clearance for any irregularities in the adjacent surfaces of the stacked enclosures.

The enclosure can include additional openings 76 and 78 for entrance and exit of cables in the rear portion of the enclosure. While a rack mounted enclosure is shown in FIG. 1, the enclosure can alternatively be wall-mounted, for example by placing screws in the rear door and then attaching the screws to the wall. The front and rear doors can be removed and replaced by a metal and/or lockable door to discourage tampering.

Cover 28 protects high fiber count cables when the cables are routed from the rear mounting position to the front of the enclosure. This prevents damage to the fibers from falling debris.

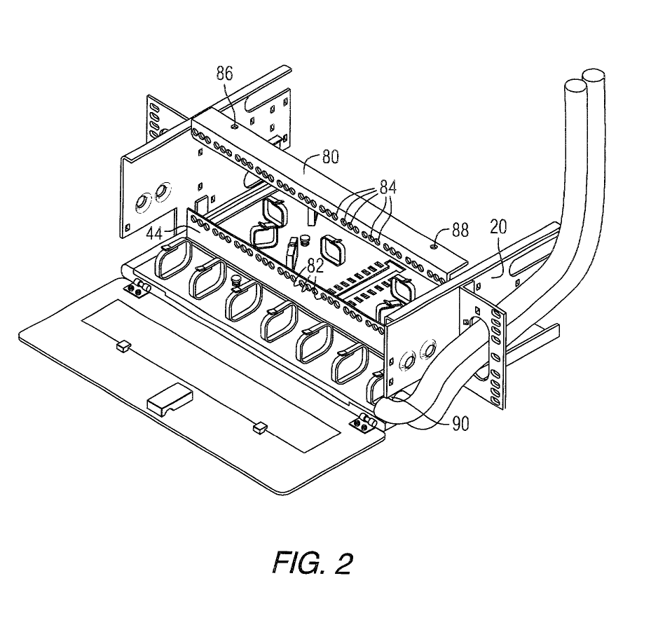

FIG. 2 is an isometric view of selected components of the enclosure of FIG. 1 with the top panel removed. This view shows an additional reversible bracket 80 mounted near the top of the interior of the enclosure. Brackets 44 and 80 are shown to include openings 82 and 84 for attachment of various fiber optic cable management devices. The brackets can also serve as means for mounting a master plate that can be used to support various known cable management devices, such as cable adapters. FIG. 2 also shows openings 86 and 88 in mounting bracket 80 for attaching the mounting bracket to the top of the enclosure and the cable entrance opening 90 in sidewall 20. In this illustrated embodiment, the openings in the sidewalls are in the form of slots having an open end at the front of the enclosure. By using such slots, cables can be routed by sliding them into the slots. This avoids the process of threading the cables through openings in the enclosure walls and can reduce the amount of bending required during the cable installation process.

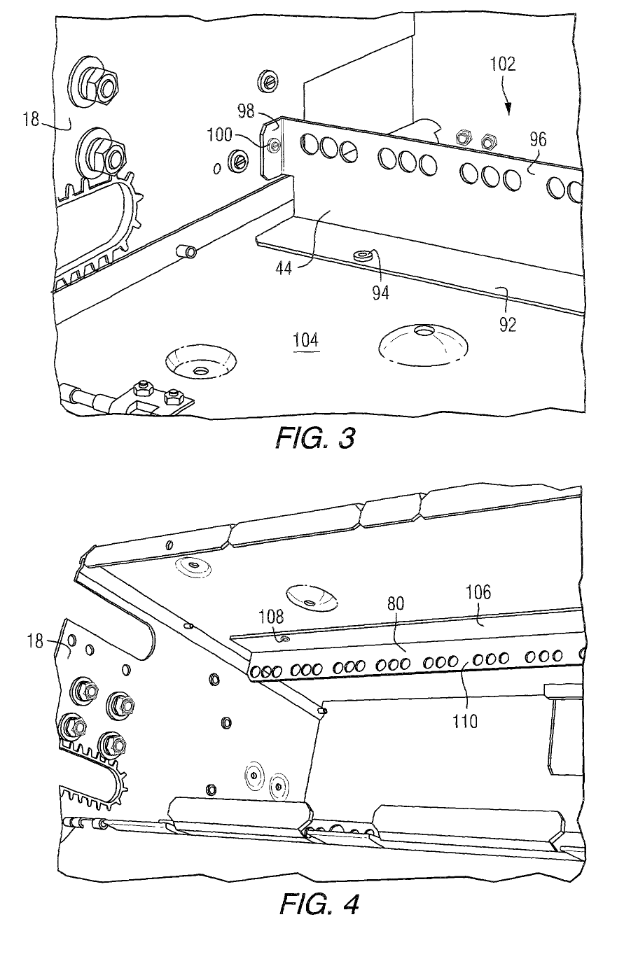

FIG. 3 is a perspective view of a portion of the bottom interior of the enclosure of FIG. 1 taken from the rear of the enclosure and showing bracket 44 mounted in a first position. Bracket 44 is shown to have a generally L-shaped cross-section. Bracket 44 includes a first portion 92 that can be fastened to the bottom of the enclosure by fastening means 94 such as screws, bolts or rivets. Bracket 44 further includes a second portion 96 that is positioned substantially perpendicular to the plane of the bottom panel. A tab 98 is attached to one end of the second portion 96. Fastening means 100 such as screws, bolts or rivets can fasten the tab 98 to the side of the enclosure. With bracket 44 installed in the position shown in FIG. 3, the bottom of the enclosure is divided into front and rear sections 102 and 104, with the front section being more narrow than the rear section.

As shown in FIG. 3, the first portion 92 of bracket 44 extends from the second portion 96 toward the rear of the enclosure. However, the mounting bracket can be reversed so that the first portion 92 of bracket 44 extends from the second portion 96 toward the front of the enclosure. When in the alternative position, additional holes may be needed to attach the tabs at the ends of the bracket to the adjacent sidewalls. By switching the orientation of the bracket, the position of the first portion changes relative to the interior of the enclosure as illustrated below in FIGS. 7 and 8.

FIG. 4 is a perspective view of a portion of the top interior of the enclosure of FIG. 1 taken from the rear of the enclosure and showing bracket 80 mounted in a first position. Bracket 80 is shown to have a generally L-shaped cross-section. Bracket 80 includes a first portion 106 that can be fastened to the top of the enclosure by fastening means 108 such as screws, bolts or rivets. Bracket 80 further includes a second portion 110 that is positioned substantially perpendicular to the plane of the top panel. With bracket 80 installed in the position shown in FIG. 4, the bottom of the enclosure is divided into front and rear sections, with the front section being narrower than the rear section.

As shown in FIG. 4, the first portion 106 of bracket 80 extends from the second portion 110 toward the rear of the enclosure. However, the mounting bracket can be reversed so that the first portion 106 of bracket 80 extends from the second portion 110 toward the front of the enclosure. When in the alternative position, additional holes may be needed to attach the tabs at the ends of the bracket to the adjacent sidewalls. Brackets 44 and 80 are mounted such that the first portions of each of the brackets are aligned vertically so that additional cable management devices can be connected to the holes in the brackets, or a master plate can be connected to the brackets.

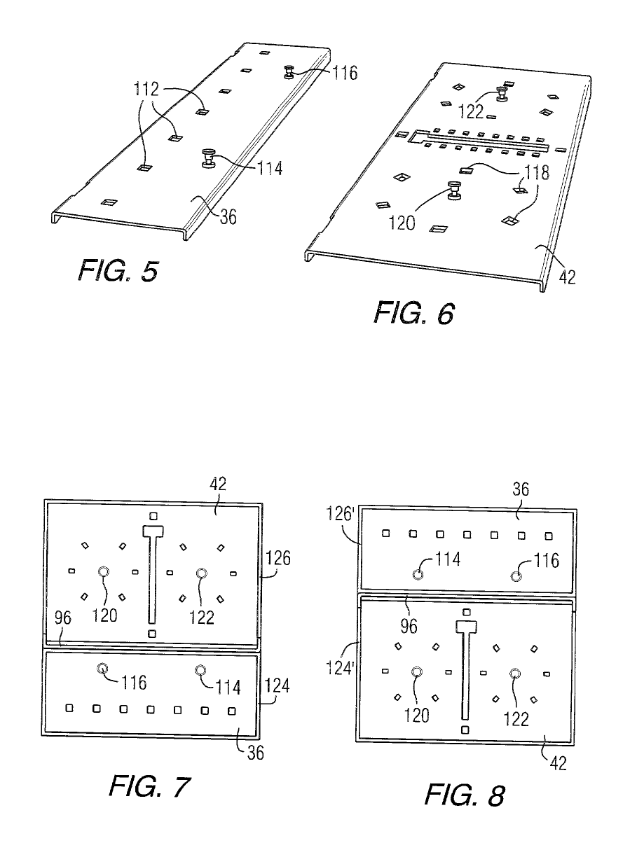

FIG. 5 is a perspective view of the first tray 36 that can be used in the enclosure of FIG. 1. Tray 36 is shown to include openings 112 that can be used to attach cable clamps as shown in FIG. 1. A pair of spring-loaded fasteners 114 and 116 are used to connect the tray to the bottom of the enclosure.

FIG. 6 is a perspective view of the second tray 42 that can be used in the enclosure of FIG. 1. Tray 42 is shown to include openings 118 that can be used to attached various known cable management devices. A pair of spring-loaded fasteners 120 and 122 are used to connect the tray to the bottom of the enclosure.

FIG. 7 is a plan view of the bottom of the enclosure showing the bracket mounted in a first position such that the enclosure is divided into two sections 124 and 126, with the front section 124 being narrower than the rear section 126.

FIG. 8 is a plan view of the bottom of the enclosure showing the bracket mounted in a second position such that the enclosure is divided into two sections 124′ and 126′, with the front section 124′ being wider than the rear section 126′.

The spring-loaded fasteners in trays 36 and 42 are positioned such that the trays can be mounted in the front or rear section of the enclosure when the bracket 44 is mounted in either the first or second position. The trays are removable and reversible in that the front tray can be used in the rear and the rear tray can be used in the front. Thus the enclosure can be reconfigured when the cable is routed from the rear mounting position to the front.

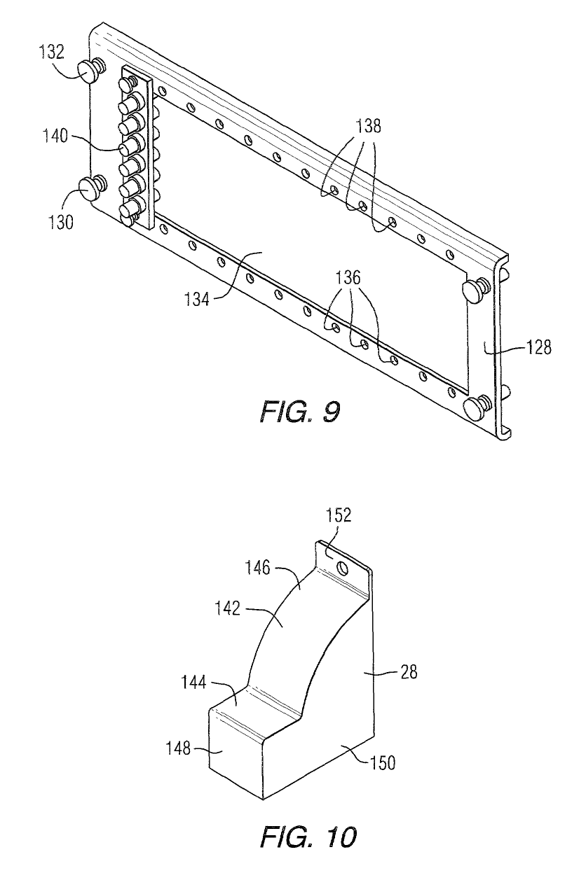

FIG. 9 is an isometric view of the master plate 128 the can be used in combination with the enclosure of FIG. 1. The plate 128 can be mounted vertically within the interior of the enclosure using, for example, spring-loaded clips 130 and 132. The plate defines a substantially rectangular opening 134. Openings 136 and 138 are provided near the opening 134 for attachment of modular cable management devices, such as module 140.

FIG. 10 is an isometric view of the cover 28 of FIG. 1. The cover includes a top portion 142 having a flat section 144 and a curved section 146. A front portion 148 extends vertically downward for the top portion. A side 150 portion conforms to the shape of the top and front portions. A tab 152 is attached to the top portion for connection to the adjacent mounting bracket. The curved section of the top portion provides a bend radius control feature for the enclosed cable. The cover is mounted such that it covers an opening in one of the mounting brackets and the opening 90 in the sidewall 20 that permits the cable to enter the enclosure.

In typical prior art enclosures, the fiber optic cables are attached to the rear of the enclosure. Cables are typically routed into the rear of the enclosure through openings in the sides. In the front of the enclosure, fiber optic jumpers are generally routed to other equipment or are provided as a cross connect between equipment made by different manufacturers. The enclosure of this invention allows for fiber optic cable to be attached in its originally intended and designed location in the rear of the housing and to be routed through the rack mounting bracket to the front of the enclosure without fear of damage to the cable caused by falling tools or debris. The cable shield 28 protects the cable as it is routed from the rack mounting bracket to the front of the enclosure. The shield is mountable after the enclosure has been installed in the rack, making it removable as well at the end user's option. The shield also enhances the normal bend radius of the cable in that it restricts the cable in three mutually perpendicular axes. The shape of the shield forces the cable to bend in predetermined directions with a large bend radius. This assists in preventing a violation of the minimum bend radius.

The master plate can support fiber optic modules or adapter plates within the enclosure. The master plate 128 can be removed for making the enclosure a splice enclosure with the addition of a splice tray holder or slide tray mechanism. The master plate is removable and reversible in order to have the cable routed from the rear mounting position to the front of the enclosure and to allow cable management in the front of the housing. The use of an interchangeable master plate allows for taller adapter plates or modules to be inserted simply by changing one piece of hardware. The holes in the master plate can be positioned to accept single and doublewide adapters and modules.

The enclosures of this invention provide for cross connects and general fiber optic cable handling. By being able to route cables to the front of the enclosure, normal fiber optic cable jumpers can be provisioned out the back side of the enclosure to cross connect modules located in other enclosures. Holes provided in the top panel accept a variety of hardware, such as splice tray drawer mechanisms, or record rack types of splice tray holding apparatus.

While the enclosures of this invention have been described in terms of particular embodiments, it will be apparent to those skilled in the art that various changes can be made to the disclosed embodiments without departing from the invention as defined by the following claims.

What is claimed is:

1. An enclosure for use in a cable management system comprising:
an outer shell having a generally rectangular shape and defining an interior space, the outer shell including a bottom panel, a top panel and first and second sidewalls;
a first reversible mounting bracket for connection to the bottom panel; and
a second mounting bracket for connection to the top panel, wherein the first and second mounting brackets include means for supporting cable management devices.

2. An enclosure according to claim 1, wherein:
the first reversible mounting bracket comprises a generally L-shaped member having a first portion positioned adjacent to the bottom panel and a second section positioned substantially perpendicular to the bottom panel; and
the second mounting bracket comprises a generally L-shaped member having a first portion positioned adjacent to the bottom panel and a second section positioned substantially perpendicular to the bottom panel.

3. An enclosure according to claim 1, wherein the means for supporting cable management devices comprises a plurality of holes in the first and second mounting brackets.

4. An enclosure according to claim 1, wherein the means for supporting cable management devices comprises a master plate having a plurality of holes for attaching the cable management devices.

5. An enclosure according to claim 4, wherein the master plate defines a substantially rectangular opening.

6. An enclosure according to claim 5, wherein the master plate defines a plurality of holes for attachment of adapters within the rectangular opening.

7. An enclosure according to claim 1, further comprising:
a door for covering a front opening of the enclosure; and
a latch attached to the door, wherein the latch is positioned adjacent to the center of one edge of the door.

8. An enclosure according to claim 1, further comprising:
an additional mounting bracket attached to the first sidewall and defining an opening for routing cables from the rear of the enclosure to the front of the enclosure; and
a cable shield for enclosing the cables between the additional mounting bracket and an opening in the first sidewall.

9. An enclosure according to claim 8, wherein the cable shield comprises:
a top portion having a flat section and a curved section;
a front portion extending vertically downward for the top portion;
a side portion conforming to the shape of the top portion and the front portion; and
a tab attached to the top portion for connection to the additional mounting bracket.

10. An enclosure according to claim 1, further comprising:
a plurality of outwardly facing dimples in the top panel, each of the dimples forming an opening for receiving a means for attaching an adjacent enclosure.
